(19) United States
(12) Patent Application Publication
(10) Pub. No.: US 2013/0041901 A1
(43) Pub. Date: Feb. 14, 2013

(54) NEWS FEED BY FILTER

(71) Applicant: Andrey N. Nikankin, Sankt-Peterburg (RU)

(72) Inventor: Andrey N. Nikankin, Sankt-Peterburg (RU)

(73) Assignee: RAWLLIN INTERNATIONAL INC.

(21) Appl. No.: 13/209,131

(22) Filed: Aug. 12, 2011

(51) Int. Cl. G06F 17/30

(52) U.S. Cl. 707/737; 707/754; 707/E17.005; 707/E17.059; 707/E17.089

(57) ABSTRACT

Disclosed are electronic systems and techniques for filtering data comprising content requested from a variety of sources, and tracking which of the sources supplied the data and a category that classifies the content. The filtering may comprise implementing a variety of filtering techniques to acquire the content. In this regard, the content can be stored and grouped with other content related to the content in data storage, while discarding a subset of the data not containing the content.

### TECHNICAL FIELD

The subject application relates to the collection of information, and, more particularly, to collecting and filtering information from different sources.

### BACKGROUND

Currently, aggregation of online content to present information to a user from numerous sources is conventionally known. A variety of applications and websites exist today to obtain and display the aggregated content from multiple sources. A conventional means of collecting online content is through web feeds (e.g., Really Simple Syndication (RSS) feeds) and online aggregators. The web feeds and online aggregators may be displayed using feed readers (e.g., RSS readers) or a website providing a specific type of aggregated content and may be viewed on a device with access to a web portal, such as a personal computer. Web feeds and online aggregators commonly provide content to users from frequently updated sources, such as blogs and news headlines.

However, the information presented by the web feeds are often cluttered and not grouped for a user to easily view requested information. In addition, web feeds and online aggregators often present a large amount of unwanted information to the user since a large amount of online content is available and frequently updated from numerous online sources. Also, the online content provided to the user by the web feeds and online aggregators do not allow a user to quickly find specific information. Since the amount of online content is continuously growing and more sources of online content are continuously becoming available, the online content can become outdated in a short amount of time. Therefore, time is wasted by users sorting through content provided by web feeds and online aggregators, and, as a result, a lot of desired information is lost in the flood of information available online. As such, conventional methods of aggregating online content lack a means to find and manage relevant information to present only relevant information to a user.

The above-described deficiencies of today's aggregation systems for online content are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for systems that incorporate filtering information are contained herein. An exemplary method is provided that includes the steps of retrieving data comprising content requested from at least one source, tracking which of the at least one source supplied the data and a category that classifies the content supplied by the at least one source, filtering the data from the at least one source to acquire the content by implementing one or more filtering techniques, and storing the content in data storage and discarding a subset of the data not containing the content, wherein the content is grouped with other content related to the content.

In another non-limiting embodiment, an exemplary aggregator system includes a monitoring component configured to retrieve data comprising content from at least one source, and track which of the at least one source supplied the data and a category that classifies the content supplied by the at least one source, and a filtering component configured to filter the data from the at least one source to acquire the content by implementation of one or more filters, store the content in data storage and discard a portion of the data not containing the content, wherein the content is grouped with other content related to the content.

In still another non-limiting embodiment, an exemplary computer readable storage medium that includes computer executable instructions that, in response to execution by a computing system, cause the computing system to perform operations, including retrieving data comprising content requested from at least one source, tracking which of the at least one source supplied the data and a category that classifies the content supplied by the at least one source, filtering the data from the at least one source to acquire the content by implementing one or more filtering techniques, and storing the content in data storage and discarding a subset of the data not containing the content, wherein the content is grouped with other content related to the content.

In yet another non-limiting embodiment, an exemplary system is provided that includes means for retrieving data comprising content requested from at least one source, means for tracking which of the at least one source supplied the data and a category that classifies the content supplied by the at least one source, means for filtering the data from the at least one source to acquire the content by implementing one or more filtering techniques, and means for storing the content in data storage and discarding a subset of the data not containing the content, wherein the content is grouped with other content related to the content.

In another non-limiting embodiment, an exemplary device includes a retrieving component configured to obtain data comprising content requested from at least one source, a tracking component configured to identify which of the at least one source supplied the data and a category that classifies the content supplied by the at least one source, a filtering component configured to sort the data from the at least one source to acquire the content by implementation of one or more filters, and a storage component configured to save the content in data storage and discard a subset of the data not containing the content, wherein the content is grouped with other content related to the content.

In still another non-limiting embodiment, an exemplary method is provided that includes collecting content related to information, monitoring a source that supplied the content and a category that classifies the information supplied by the source, sorting the content from the source by implementing one or more sorting techniques, and saving the information and discarding a subset of the content not containing the information, wherein the information is parsed with other information related to the information.

These and other embodiments are described in more detail below.

### BRIEF DESCRIPTION OF DRAWINGS

FIG. 1 illustrates an example of an aggregator system;

FIG. 2 illustrates an example of an aggregator system with various sources of information in accordance with various aspects described herein;

FIG. 3 illustrates an example of an aggregator system with various filtering techniques in accordance with various aspects described herein;

FIG. 4 illustrates an example collection of information in accordance with various aspects described herein;

FIG. 5 illustrates an example software application in accordance with various aspects described herein;

FIG. 6 illustrates an example of a user device in an aggregator system;

FIG. 7 illustrates an example of another embodiment of an aggregator system;

FIG. 8 illustrates an example of a data storage in an aggregator system;

FIG. 9 is a flow diagram illustrating an exemplary non-limiting process for an aggregator system;

FIG. 10 is a flow diagram illustrating an exemplary non-limiting process for filtering information;

FIG. 11 is a flow diagram illustrating an exemplary non-limiting process for collecting and sorting information;

FIG. 12 is a block diagram representing exemplary non-limiting networked environments in which non-limiting embodiments described herein can be implemented; and

FIG. 13 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

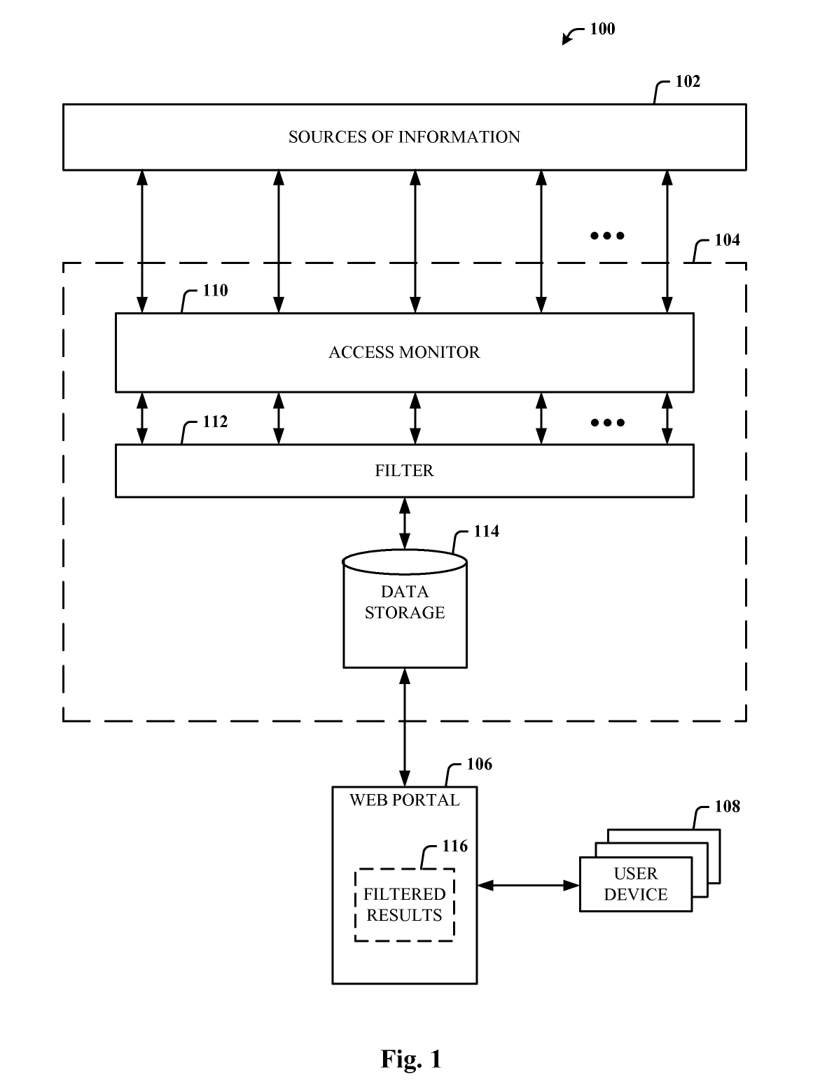

Referring initially to FIG. 1, illustrated is an example system 100 in accordance with various aspects described herein. The system 100 includes sources of information (e.g., online content, websites, data files, etc.) 102, an aggregator component (e.g., monitoring component, filter component) 104, and a web portal (e.g., webpage) 106. A user device (e.g., personal computer, mobile phone, handheld device, etc.) 108 can access filtered results 116 (e.g., information, content, data, etc.) provided by the aggregator component 104 via the web portal 106. The aggregator component 104 includes an access monitor (e.g., monitoring component, tracking component, retrieving component) 110, a filter component 112, and a data storage device (e.g., catalogue, database, etc.) 114. However, the aggregator 104 can be integrated with the web portal 106. The aggregator component 104 retrieves content (e.g., information, data, requested content, desired content, etc.) related to requested information from the sources of information 102. The content from the sources of information 102 may or may not contain additional content unrelated to the requested information (e.g., unwanted information). The sources of information 102 can be presented in various formats including, but not limited to, RSS, Atom (e.g., Atom Syndication Format), HyperText Markup Language (HTML), text file (e.g., TEXT), and/or Extensible Markup Language (XML).

The aggregator component 104 enables the extraction of useful information from the sources of information 102. The extracted information can be used in a variety of systems for a number of different purposes, such as electronic commerce systems, academic systems, financial systems, business systems, social networking systems, non-commercial systems, etc. However, it is to be appreciated that the foregoing are merely examples and that other systems can be included. The extracted information can be presented to a user and/or stored in a data file (e.g., product feed, XML, Resource Description Framework (RDF), etc.). The aggregator component 104 provides more specific information to a user than conventional methods to allow a user to receive requested information. The aggregator component 104 tracks which of the sources of information supplied the content (e.g., the origin of the information) and the type of content supplied by the one or more sources of information (e.g., genre of content, format of content, etc.). It is to be appreciated that the foregoing are merely examples, and the aggregator 104 can collect, filter and/or display information based on virtually any criteria.

The access monitor 110 enables the tracking and/or monitoring of the origin of the source of information. The origin of the source of information can be used to determine the name of the source from which content is extracted from and/or where particular content was obtained (e.g., the website address, Uniform Resource Locator (URL), etc.). Additionally or alternatively, the access monitor 110 can be used to determine the type of format (e.g., data file) the content was retrieved from and/or a category to classify the content. The filter component 112 facilitates a plurality of filter techniques to obtain the requested content and discard content not requested (e.g., a subset of data) from the sources of information 102. The filtered sources of information 102 can then be maintained in the data storage 114 associated with the system 100. It is to be appreciated that the data storage 114 can be internal or external. It is further to be appreciated that the data storage 114 can be located separate from the aggregator 104. In one example, the data storage device 114 is implemented as a hard disk drive. In another example, the data storage device 114 is implemented as a plurality of hard disk drives arranged in a server system. The data storage device 114 allows content from the sources of information 102 to be saved and presented to a user. The saved information can be grouped with related content in a categorized structure. The saved information can be parsed to create a data structure and/or indexed in a memory array.

The aggregator 104 can determine a source of origin for content from the sources 102 by annotating, maintaining, or otherwise associating an indicator with the content identifying the source of origin for the content. The source of origin (e.g., history of origin) is the name of the source from which content was obtained. This feature can assist in finding additional sources of information and can make later searches more efficient. For example, if content from a particular source is more frequently accessed compared to a random selection by the system, and thus the system may provide better results based on the source of content discovery. As an additional example, if requested information relates to a research project, then content obtained from an academic journal may be more useful than content obtained from an internet website. Thus the history of origin may be the name of a website, name of an online search engine, a source, a genre for the information, and the like. The indicator can help categorize and/or classify the content with other related content.

The aggregator component 104 comprises open interfaces that track who and what applications plug into the aggregator component 104. In one example, the access monitor 110 tracks and/or monitors the sources of information 102 to make later searches with similar characteristics more efficient. The access monitor 110 tracks, ascertains, or otherwise determines a source of origin for the requested content, and associates, maintains, or otherwise links information relating to the source of origin with the requested content. In another example, previously searched and acquired content is used to narrow down a search to a smaller field of information. This can provide a faster and a more accurate means of data collection to obtain requested content.

In another embodiment, the access monitor 110 can track and monitor the sources of information to determine hotspots (e.g., information that is being requested frequently). Therefore, information that is being requested more frequently can be accessed and gathered before information that is less frequently requested. The information that is less frequently requested can comprise fewer immediate filtering techniques compared to the information that is more frequently requested. As a result, more accurate filtered results 116 can be presented to a user.

In one example, after finding requested content form the sources of information 102, the aggregator component 104 collects and filters information from a data file associated with the requested content (e.g., read content from XML files). The data files can provide information, such as a link to a URL, a description of a product or good, etc. This information from the data file can be stored, grouped, and/or associated with the requested content.

The system 100 provides specific content requested by a user from the sources of information 102. The access monitor 110 filters the content and stores the content on the data storage device 114. The user can use a user device 108 (e.g., personal computer, laptop, tablet, handheld device, smart phone, etc.) to search for the content (e.g., information, topic, item, etc.) using a web portal 106 (e.g., website). In another example, the content can be presented to the user automatically based on previous searches and/or criteria input by the user. The data storage 114 can be accessed by the user device 108 via the web portal 106 to access information pertaining to the requested content. In one example, the content stored on the data storage 114 can also be filtered and presented as the filtered results 116 via the web portal 106. Therefore, the sources of information 102 can be filtered, as well as content already stored on the data storage device 114. As such, the filter 112 can be implemented before the data storage device 114, after the data storage device 114, or before and after the data storage device 114.

A software application associated with the aggregator component 104, or including one or more features of the aggregator component 104, can be downloaded to a user computer or device, or accessed online via a network connection. The user device 108 can include but is not limited to a personal computer, a laptop, a tablet, a personal digital assistant (PDA), a cell phone, a smart phone, a gaming system, a streaming media device, a portable music player, a digital camera, or an internet-connected television. The user device 108 can also be a plurality of user devices to allow more than one user access to the aggregator component 104.

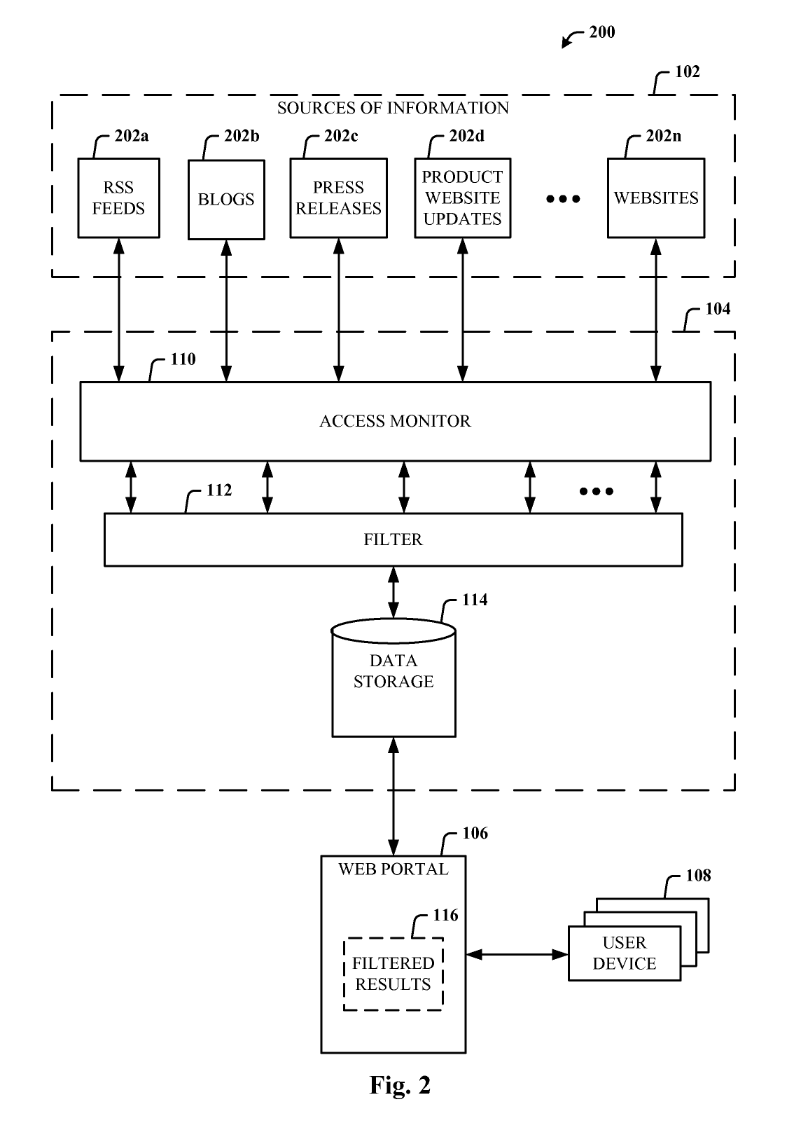

Turning to FIG. 2, illustrated is an example system 200 in accordance with various aspects described herein. The system 200 includes sources of information 102, an aggregator component 104, and a web portal 106. The sources of information 102 include one or more sources 202a-n. The sources 202a-n can include RSS feeds, blogs, official press releases, product website updates, other websites, and/or other sources of information available online. The sources 202a-n can comprise various forms of interesting and/or useful information requested by a user. For example, the sources 202a-n can include information pertaining to products, goods, services, items, entertainment, e-commerce, education, etc. However, it is to be appreciated that the sources 202a-n can pertain to a number of other types of information. In one example, the sources 202a-n may comprise information that has already been collected and grouped (e.g., aggregated information from a web feed and/or online aggregator). The sources 202a-n can be of the same format (e.g., markup language) and/or different types of formats. For example, a source 202a can be in a RSS format, a source 202b can be in an HTML format, and a source 202c can be in a TEXT format. However, it is to be appreciated that the type and/or number of formats may be varied. The sources of information 102 can include other aggregators of information, such as news aggregators, review aggregators, and/or search aggregators. By using other aggregators of information as the sources of information 102, the aggregator component 104 can provide better quality information, more accurate information and/or more specific information to a user.

In one embodiment, the aggregator 104 can be implemented to filter a news feed (e.g., RSS feed) from a source 202a. The new feed can comprise information relating to various topics (e.g., news headlines) from various providers of information. The aggregator component 104 allows requested content pertaining to a specific topic to be filtered, grouped, and presented from the news feed source 202a, while discarding a subset of data (e.g., unrequested content).

In another embodiment, the aggregator 104 can be implemented to filter a blog from a source 202b. The blog can contain a number of different sources of information including comments from a number of users and links to other websites containing requested content. The aggregator 104 can extract relevant information (e.g., requested content) from the blog and from other relevant sources provided from the blog. A number of filtering techniques can be implemented by the aggregator component 104 to filter an entire chain of comments on the blog and determine which of the comments relate to the requested content.

In yet another embodiment, the aggregator 104 can be implemented to filter a press release from a source 202c. The press release source 202c can be written text or a video file. The press release source 202c can comprise sales figures for a company, new products, company announcements, changes in corporate structures, etc. In one example, the press release source 202c is used to obtain requested information relating to a specific stock (e.g., capital stock). The aggregator component 104 allows requested content pertaining to the stock to be filtered, grouped, and presented from the press release source 202c, while discarding unrequested content from the press release source 202c.

In another embodiment, the aggregator 104 can be implemented in connection with consumer goods. For example, the aggregator 104 can be implemented to filter product website updates from a source 202d. The product website updates 202d can comprise information related to a specific product on a website, such as prices of the specific product, reviews of the specific product, user comments regarding the specific product, availability of the specific product, estimated time of delivery, etc. In one example, the aggregator 104 can also be implemented to compare information pertaining to the product from the source 202d to information stored on the data storage device 114. Therefore, updates to a specific product or similar products can be presented to a user automatically. The information pertaining to the particular product can be grouped and easily reviewed on the user device 108. For example, a plurality of information pertaining to the particular product can be grouped and presented to a user via the web portal 106. In one example, a plurality of information comprising reviews of the particular product can be grouped together, a plurality of information comprising costs of the particular product can be grouped together, etc. The user can then choose which group of information (e.g., reviews, costs, etc.) to view.

In another embodiment, the aggregator component 104 is implemented to filter content on social network sites. The aggregator component 104 can be used to filter information from frequently updated news feeds and/or subscriber content on social network sites. For example, the aggregator component 104 can filter information about social networking friends of a user from multiple social networking sites. Therefore, a user can acquire specific content from comments made by social networking friends, interests of social networking friends, pictures and/or videos posted by social networking friends, etc.

In one embodiment, the aggregator component 104 is implemented as a media aggregator for audio and/or video files. In one example, music is grouped and stored based on keywords relating to the musical taste of a user and/or past purchases of music. The aggregator component 104 can filter and group information related to particular music to allow a user to find new music. Therefore, a user in search for a song similar to a particular type of song can be found, based on a search criteria specified by the user. For example, words associated with a particular musical artist can be used to filter and find similar musical artists. In another example, a listing of videos, movies, streaming multimedia products and/or films is automatically provided to a user based on keywords relating to the preferences of a user. Therefore, a user can find a movie to watch by implementing user specified filtering techniques.

Requested content from the sources 202a-n can be a multimedia file, such as a movie, film, video, television show, news clip, streaming-video, etc. During playback of a multimedia file of a user, one or more data fields can be stored in the data storage 114. The fields can include a basic info field that includes data relating to the release year of the multimedia file, the country of origin for the multimedia file, the title of the multimedia file, etc. In addition, the fields can include a category field that details at least one group, class, or collection to which the multimedia file belongs. The fields can further include a rating field that can include ratings from websites, users, and so forth. A set of links to various categories related to the multimedia file can be provided in a category links field. Additionally, the fields can include a source of origin field that identifies the location where the content was originally retrieved. The number of times that the multimedia file has been viewed can be displayed via a number of views field. It is to be appreciated that a plurality of additional fields can be included. The fields can be used to acquire additional multimedia files with similar field characteristics.

In another embodiment, the sources 202a-n can additionally or alternatively be an academic system that includes an academic component that enables users to view online references to information or information links, such as academic journals, research papers, websites, and so forth. Additionally or alternatively, the aggregator 104 can facilitate receiving, filtering, and storing information from a number of other websites, such as e-commerce websites, disparate portals, internet advertisements, message boards, chat rooms, application markets, etc. The sources 102a-n can also include discussion forums, fan sites, news sites, online product databases, online recommendation and references sites, dictionaries, wilds, user blogs', search engines, decision guides, search engines, social network services, etc. Retrieval of the information can be facilitated through open authorization protocol depending on the network related functionality, to allow standard and secure application programming interface (API) multi-domain authentication and authorization.

The aggregator 104 is coupled to the sources 202a-n via any suitable and/or necessary adapters, connectors, channels, communication paths, etc. to integrate the list component 106 into virtually any operating, communication, and/or database system(s). Moreover, the aggregator 104 can provide various adapters, connectors, channels, communication paths, etc., that provide for interaction with the system 200 through a number of different transport protocols.

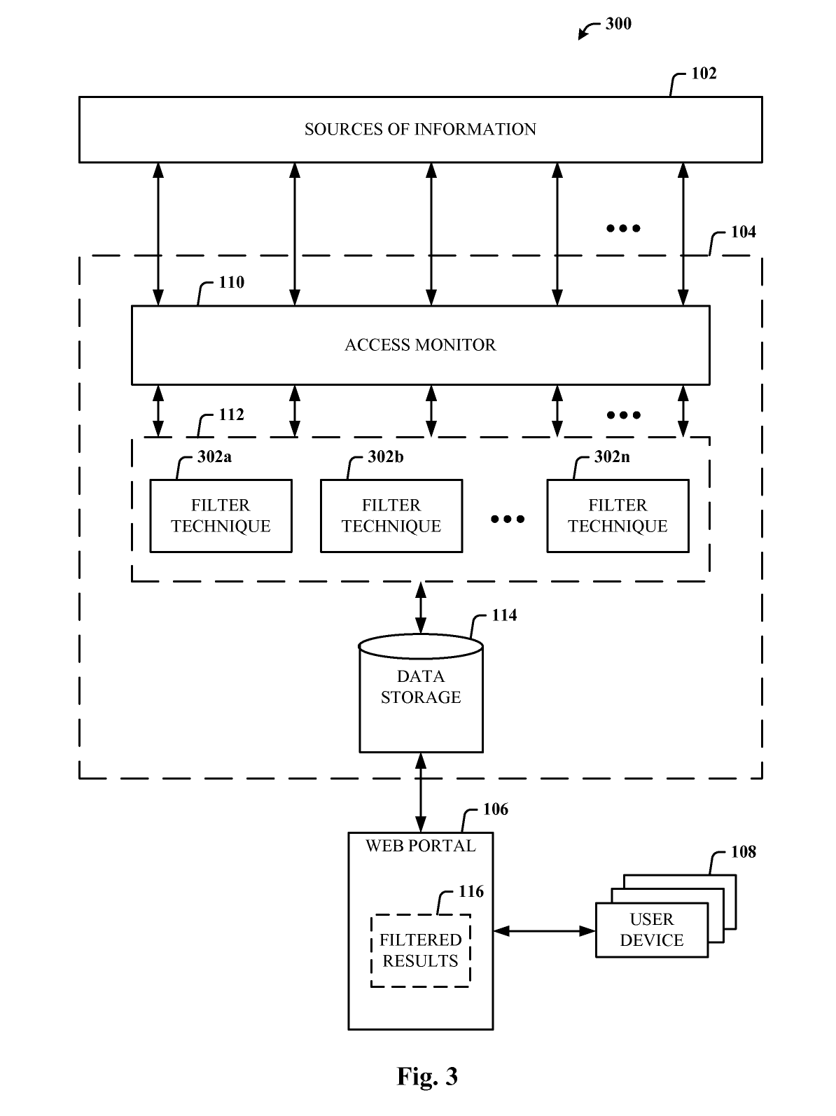

Referring now to FIG. 3, illustrated is an example filter 112 in accordance with various aspects described herein. The system 200 includes sources of information 102, an aggregator component 104, and a web portal 106. The aggregator component 104 includes an access monitor 110, a filter component 112, and a data storage device 114. The filter 112 includes a plurality of filter techniques 302a-n. The filter techniques 302a-n are used to extract interesting and useful information (e.g., content about a product, service, good, topic, etc.) from the sources of information 102. In one example, the filter techniques 302a-n is based on one or more keywords provided by a user (e.g., user specified search criteria). Each source of information can undergo one or more filtering techniques 302a-n or different sources of information can each undergo a distinct filtering technique 302a-302n.

In one embodiment, the filtering techniques 302a-n filter content related to a particular movie on a thematic blog. The thematic blog can contain a blog entry and a thread of comments from various users related to the entry on the thematic blog. Both the blog entry and the thread of comments can be used to collect and store information relating to the particular movie. In addition, links found in the blog and/or in the thread of comments can be used to acquire additional sources of information. Therefore, the source of information can lead to another source of information, which can lead to another source of information, etc. As a result, one of the sources 202a-n can be used to acquire additional, distinct sources of information. Additionally, other comments and/or posts associated with and/or created by users who commented on the blog can be used to acquire additional content pertaining to the movie.

In one example, the first comment in a chain of comments on the thematic blog is posted by one user, and contains a link to the movie. The remaining comments in the chain of comments may or may not relate to the movie. The filter techniques 302a-n can analyze the entire chain of comments and determine which of the comments pertain to the movie of interest and which of the comments do not pertain to the movie. The comments that do not pertain to the movie are discarded. However, the comments that do pertain to the movie are saved and grouped in the data storage device 114. Then, the links found pertaining to the movie can be used as new additional sources of information. Therefore, a user does not have to search numerous sources of information and/or read all the contents and comments on the blog to acquire information about the movie. In one example, the filtering techniques 302a-n are based on user specified search criteria, including but not limited to, keywords, the name of the movie (e.g., original title), year of release, genre, actors names, director/producer names, a similarity (e.g., similar plots, other movie associations), etc. The user specified search criteria can be compared to words stored in an associative array. In one embodiment, one of the filter techniques 302a-n can be similarity of associations. For example, for the movie Knockdown, similar by association are movies in which keywords (e.g., tags) in the title and/or description of the movie are found in an associative array (e.g., boxing ring bell, the referee, the cap, hook, fight, knockout, knockdown, round, sports). In this regard, a user can find the movie Knockdown by typing in the keywords “boxing ring bell” and “fight”.

In yet another embodiment, one of the filter techniques 302a-n can be by flood. For example, the filter techniques 302a-n can discard comments containing insults, messages addressed to other participants of the blog, and/or messages that do not relate directly to the line to discussion the movie. As a result, unwanted information can be discarded. Therefore, if a large string of comments exist on a website (e.g., blog), only comments with relevant information relating to original line of discussion is saved in the data storage device 114. All other data is discarded.

In yet another embodiment, one of the filter techniques 302a-n can automatically collect similar movies based on heterogeneous information related to the movie of interest. The similar movies are grouped and can be presented on the web portal 106 in a variety of event notifications (e.g., segments of information).

It is to be appreciated that the foregoing are merely examples, and the filtering techniques can filter information based on virtually any criteria. For instance, reviews, news, press releases, discussion boards, and other groups of information implement the filtering techniques 302a-n to any type of requested information.

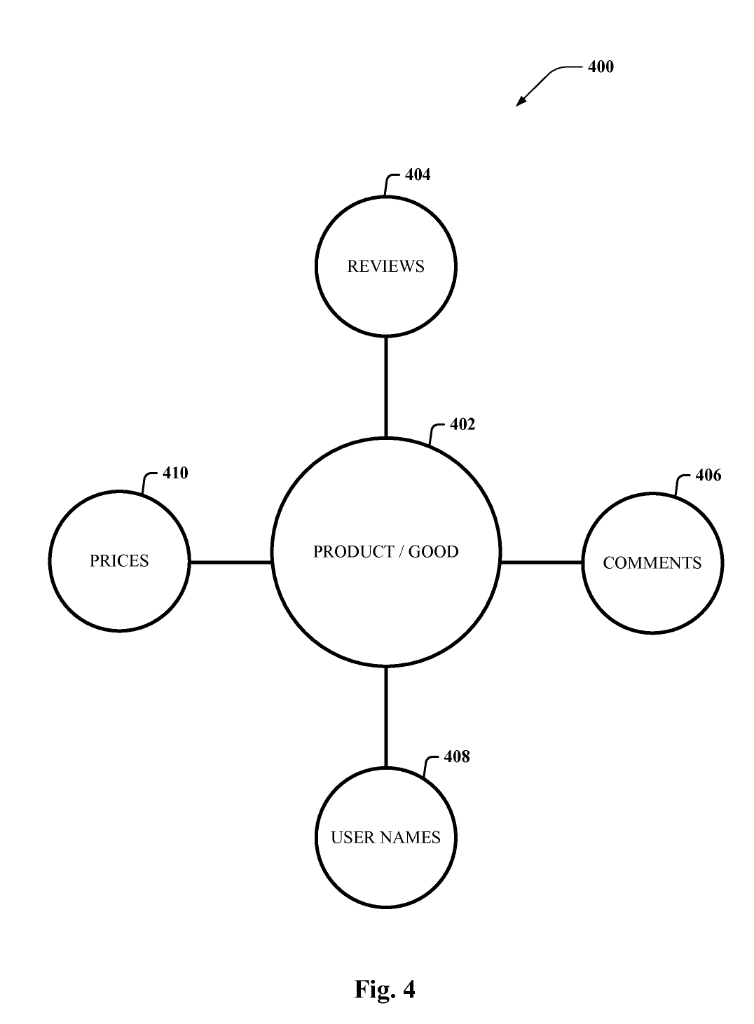

Referring now to FIG. 4, illustrated is an example of a categorized structure 400. The categorized structure 400 illustrates a set of interconnections to group information together pertaining to a particular product or good 402. The groups of information 404, 406, 408 and 410 are genres of information related to the product or good 402. Each of the groups of information 404, 406, 408 and 410 can be information from one or more sources of information pertaining to the product or good 402. In one example, each of the groups of information 404, 406, 408 and 410 can be presented to a user as an expandable list of information. As a result, a user can choose which groups of information pertaining to the product or good 402 to view.

For example, the product or good 402 can comprise a number of different segments of information from a source all related to the product or good 402. One segment of information 404 can comprise one or more reviews of the product or good 402. Another segment of information 406 can comprise one or more user comments of the product or good 402. Yet another segment of information 408 can comprise one or more user names associated with a comment about the product or good 402. Another segment of information 410 can comprise one or more prices of the product or good 402. All the segments of information 404, 406, 408 and 410 are related to the same product or good 402 and can therefore be grouped together to form a network of information (e.g., the categorized structure 400) relating to the product or good 402. The categorized structure 400 need not be considered a flat structure. The categorized structure 400 may include multiple levels, e.g., hierarchical levels, which may be categorized in a variety of ways.

The aggregator component 104 can save the information related to the product or good 402 in the categorized structure 400. For example, the product or good can have a large amount of content available pertaining from a number of different sources of information. Each time information is extracted from a particular source of information, the content can be grouped and linked to the particular item as the groups of information 404, 406, 408 and 410. Then the particular source of information can be used to find another source of information with new content about the product or good 402. Therefore, the new content can be added to the groups 404, 406, 408 and 410 to be grouped and linked to the product or good 402. If multiple sources of information contain similar types of content (e.g., multiple sources of information provide a review of the product or good), those similar types of content can also be grouped and/or linked together. Then, if a user wants to see all reviews about the product or good 402, the reviews can be easily presented since the reviews are already linked and grouped together.

The access monitor 110 can track which of the sources of information 102 supplied particular content and/or the type of content supplied by the sources of information 102. Therefore, the origin of the information can be stored and saved. In one example, the information can be stored in groups (e.g., groups of information 404, 406, 408 and 410) pertaining to similar content (e.g., the product or good 402). For example, all reviews about the product or good 402 can be grouped together (e.g., in a group of information 404). In another example, different types of information associated with the product or good 402 can be linked to the product or good 402 (e.g., the groups of information 406, 408, and 410). The grouped information can be used to make later searches about the product or good 402 more efficient. The grouped information can also be used to find more information about the product or good 402, or to find a similar product or good. It is to be appreciated that the foregoing are merely examples, and the grouping techniques can group any type of information based on virtually any criteria.

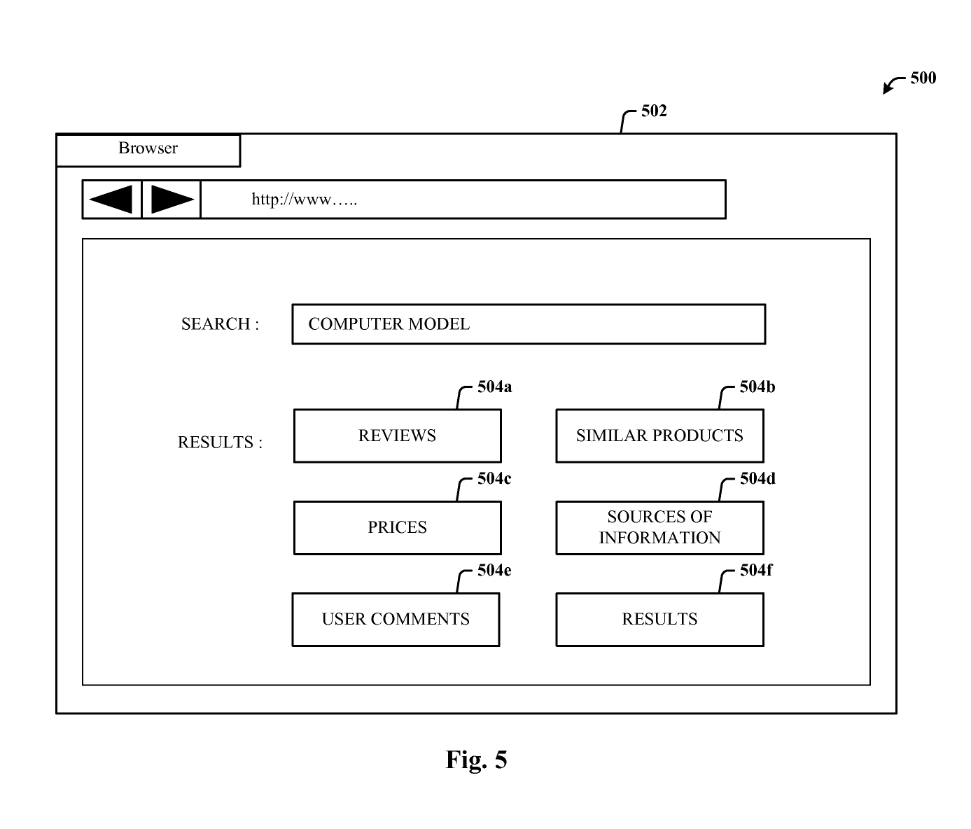

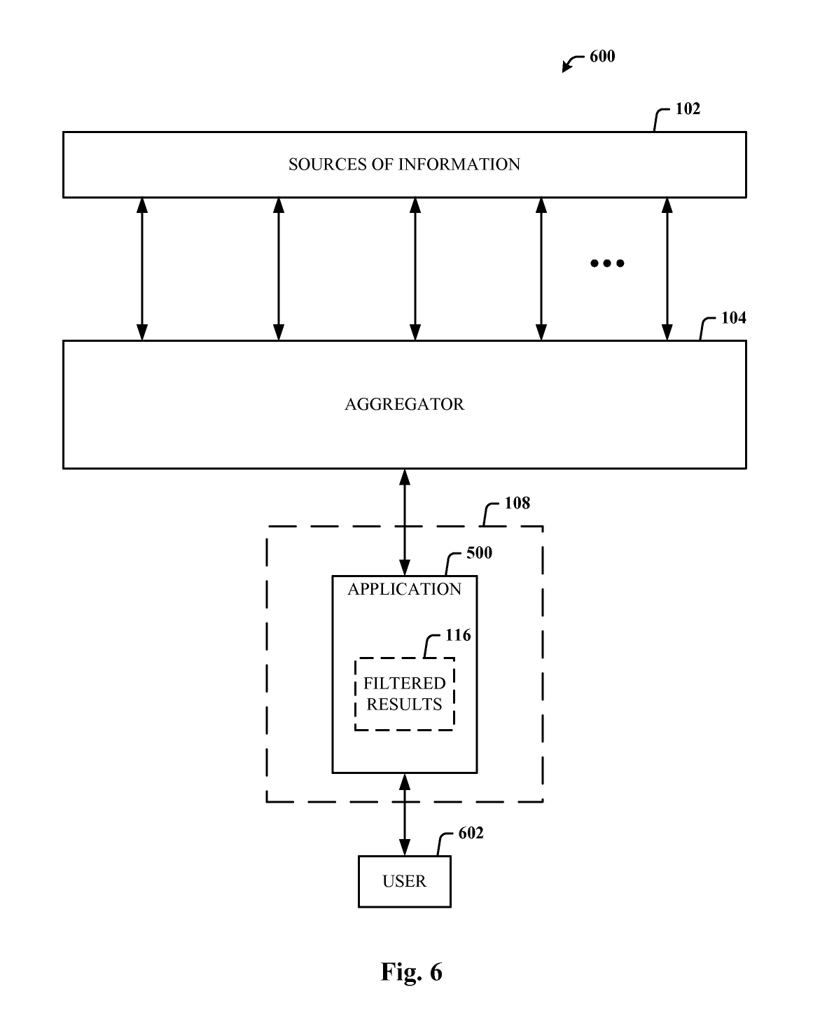

In view of the example systems described supra, various exemplary embodiments that may be implemented in accordance with the disclosed subject matter may be better appreciated with reference to FIG. 5-6. While for purposes of simplicity of explanation, the embodiments are shown and described as collecting and filtering information with reference to a product, the subject matter can be applied to virtually any system, including non-commercial systems, academic systems, and other commercial systems.

Referring to FIG. 5, illustrated is an example of an aggregator software application 500, in accordance with various aspects described herein. The application 500 can be a standalone software application for a computer or user device 108. The aggregator software application 500 can be downloaded from the web portal 102, and installed in a user device 108 in order to enable users to acquire filtered information from the sources 102a-n. The user device 108 can include but is not limited to a personal computer, a laptop, a tablet, a personal digital assistant (PDA), a cell phone, a smart phone, a gaming system, a streaming media device, a portable music player, a digital camera, or an internet-connected television. The software application 500 can be downloaded from a website or an application market or store, and installed on the user device 108. Additionally or alternatively, the software application can be maintained online, wherein a user can access and execute the application, via a network connection, without having to install the application on a user device 108.

As illustrated, the application 500 can be integrated into a web browser 502. The web browser 502 can enable retrieving, presenting, and traversing information resources on the World Wide Web, private networks, or in file systems. For example, a user can obtain filtered information from a plurality of websites using the web browser 502. The web browser 502 can allow integration of add-on applications, for example, via an application programming interface (API).

In operation, the user can search for information relating to a particular product (e.g., a specific computer model). The aggregator software application 500 provides filtered information relating to the product for the user to view. The filtered information is grouped into segments of information (e.g., separate notifications) 504a-f to allow the user to view specific types of information pertaining to the product. The segment 504a can include reviews, the segment 504b can include products similar to the product, segment 504c can include prices, segment 504d can include the sources of the information, segment 504e can include user comments, and segment 504f can include other results pertaining to the product. Each of these segments 504a-504f can acquire the information form one or more sources of information. Each of the segments 504a-504f can be expanded to allow the user to view all the information pertaining to the product (e.g., a user can click on the reviews segment 504a and see all reviews from multiple sources of information).

Referring to FIG. 6, illustrated is an example system 600 with the user device 108 in accordance with various aspects described herein. The user device 108 can include the aggregator software application 500. In one example, the aggregator software application 500 is a standalone software application for the user device 108. In another example, the aggregator software application 500 is downloaded from the internet (e.g., World Wide Web) or another network, and installed on the user device 108. In yet another example, the aggregator software application 500 is implemented on a web browser (e.g., a website) and accessed by the user device 108. The user device 108 can present the filtered results 116 to a user 602 via the aggregator software application 500. In one example, the aggregator software application 500 presents the segments of information 504a-f. However, it is to be appreciated that various ways to display the filtered content (e.g., the filtered results 116) from the sources of information 102 can be implemented. The user device 108 allows the user 602 to specify search criterion to acquire a compilation of information. For example, the user 602 can input keywords using the user device 108 to compare the keywords to similarly associated content. The user device 108 also allows the user 602 to manage the content presented to the user 602 from the aggregator 104.

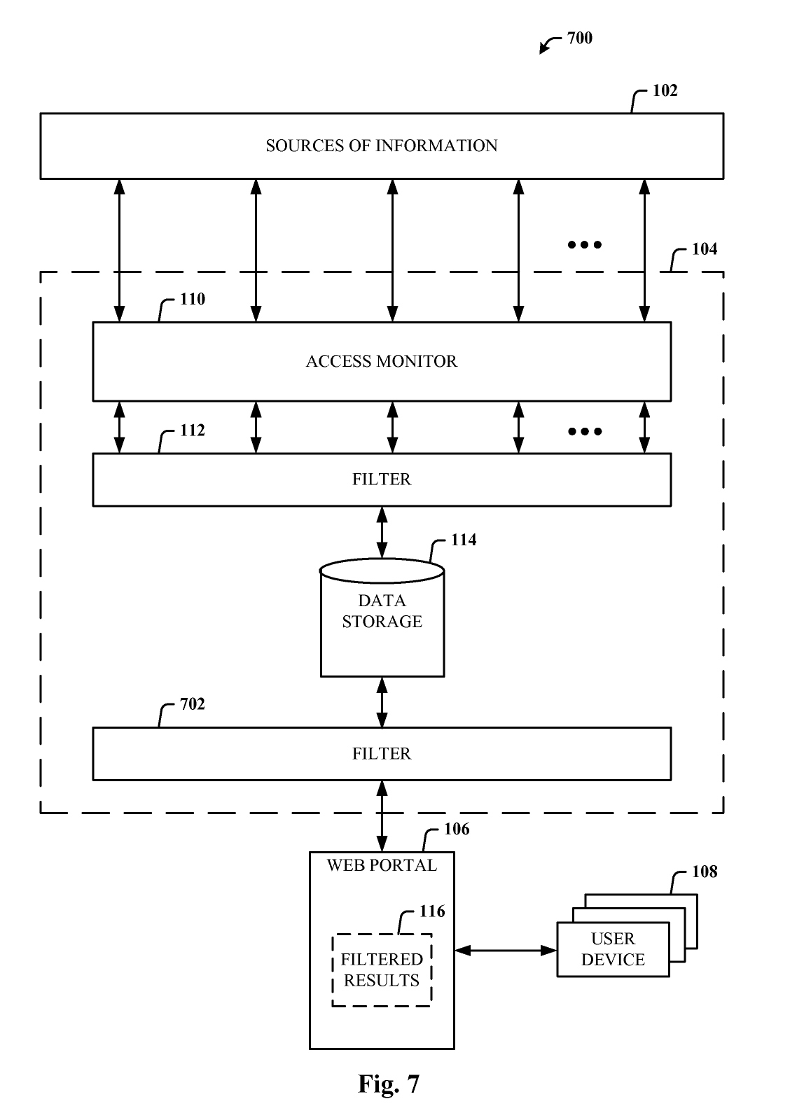

Referring now to FIG. 7, illustrated is an example system 700 with the filter 112 and a filter 702 in accordance with various aspects described herein. The aggregator component 104 includes the access monitor 110, the filter 112, the data storage device 114, and the filter 702. The filter 112 is implemented to filter content from the sources of information 102. Additionally or alternatively, the filter 702 is implemented to filter content stored in the data storage device 114. Therefore, one or more filtering techniques can be implemented to filter the content from the sources of information 102 and/or one or more filtering techniques can be implemented to filter content from the data storage device 114. In one example, the one or more filtering techniques implemented to filter the content from the sources of information 102 is different than the one or more filtering techniques implemented to filter the content from the data storage device 114. In another example, content from the sources of information 102 is not filtered before being stored on the data storage device 114, but after being saved on the data storage device 114.

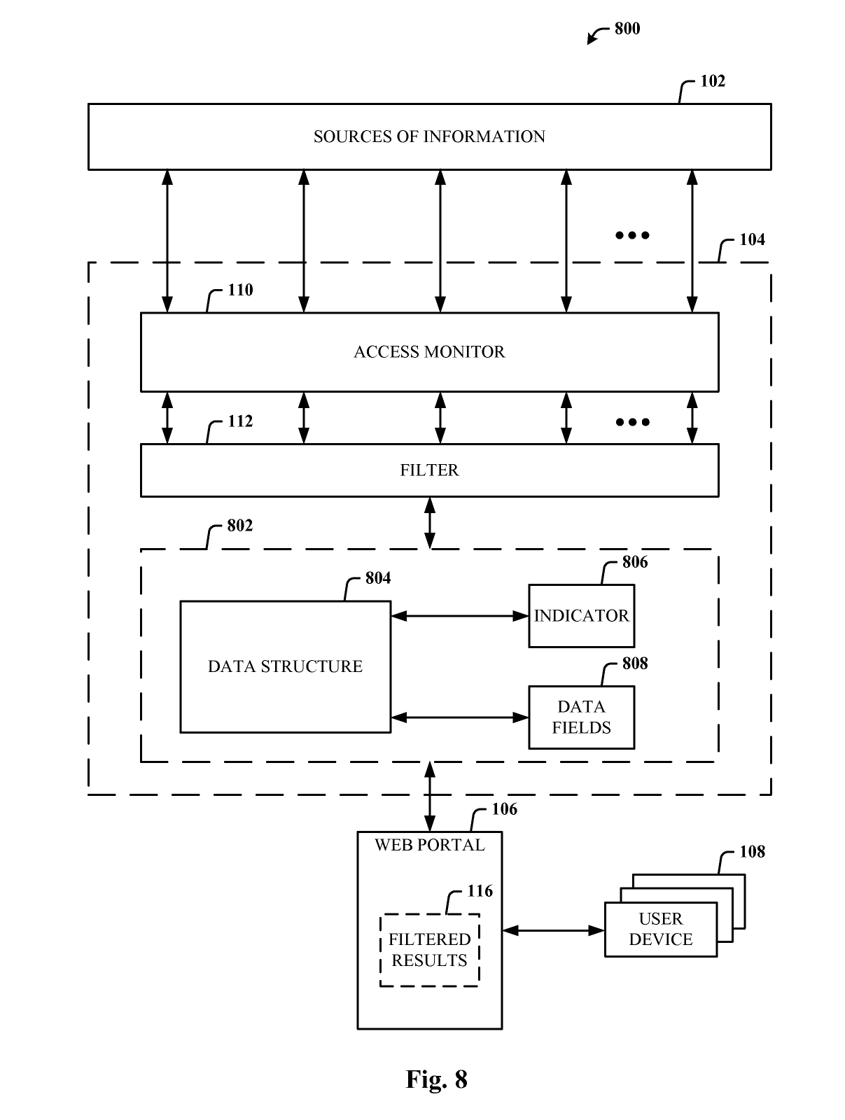

Referring now to FIG. 8, illustrated is an example system 800 with a data storage device 802 in accordance with various aspects described herein. The data storage device 802 can comprise a data structure 804 to store content (e.g., filtered content) from the sources of information 102. The data storage device 802 can also store other content related to the content in the data structure 804. Content from a previous source from which previously acquired content, including the other content related to the content, can be grouped and stored in the data structure 804 with the content. The data structure 804 can be categorized to sort and/or organize information. Information in the data structure 804 can be parsed and/or indexed. An indicator 806 can be stored with the content to identify which of the sources of information 102 supplied the content. The indicator 806 can be linked to the data structure 804. Additionally or alternatively, one or more data fields 808 in connection with the content in the data structure 804 can be implemented to classify the content in the data structure 804.

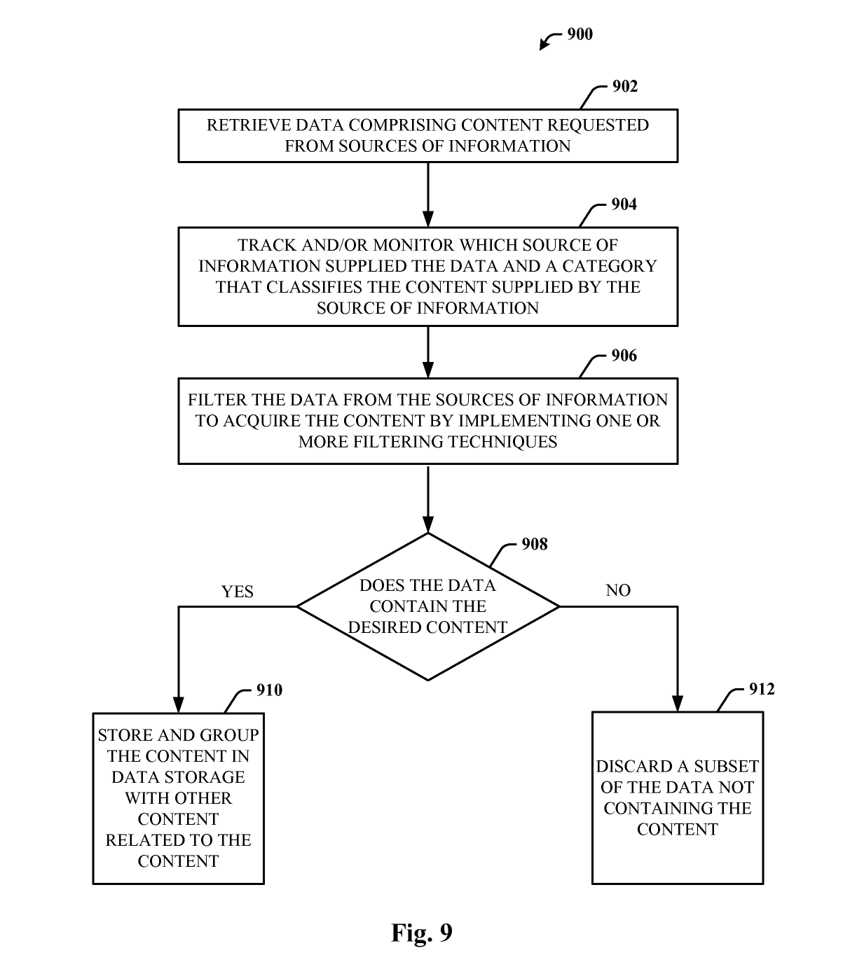

In view of the example systems described supra, methods that may be implemented in accordance with the disclosed subject matter may be better appreciated with reference to the flow charts of FIGS. 9-11. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 9, illustrated is an example methodology 900 for retrieving and filtering information in accordance with aspects described herein. Methodology 900 can begin at block 902, wherein data comprising content (e.g., requested content) is retrieved from sources of information. For example, information pertaining to a product can be retrieved from a news source, a blog, and/or an online retail store. At 904, the type of category that classifies the content supplied by the sources of information and which source of information supplied data is tracked and/or monitored. For example, the type of content supplied can be the price of the product, and the source of information can be a website where the product is currently being sold (e.g., the URL and/or name of the website). At 906, the data from the sources of information is filtered to acquire the content by implementing one or more filtering techniques. For example, content from a blog (e.g., comments from users about the product) can be filtered. At 908, it is determined if the data contains the content. If yes, 910 stores and groups the content in data storage with other content related to the content. For example, the product from the website can be grouped with other content with the same genre. If no, 912 discards a subset of the data not containing the requested content. For example, a comment in a chain of comments from a blog may not relate to the product, but the first comment in the chain of comments relates to the product.

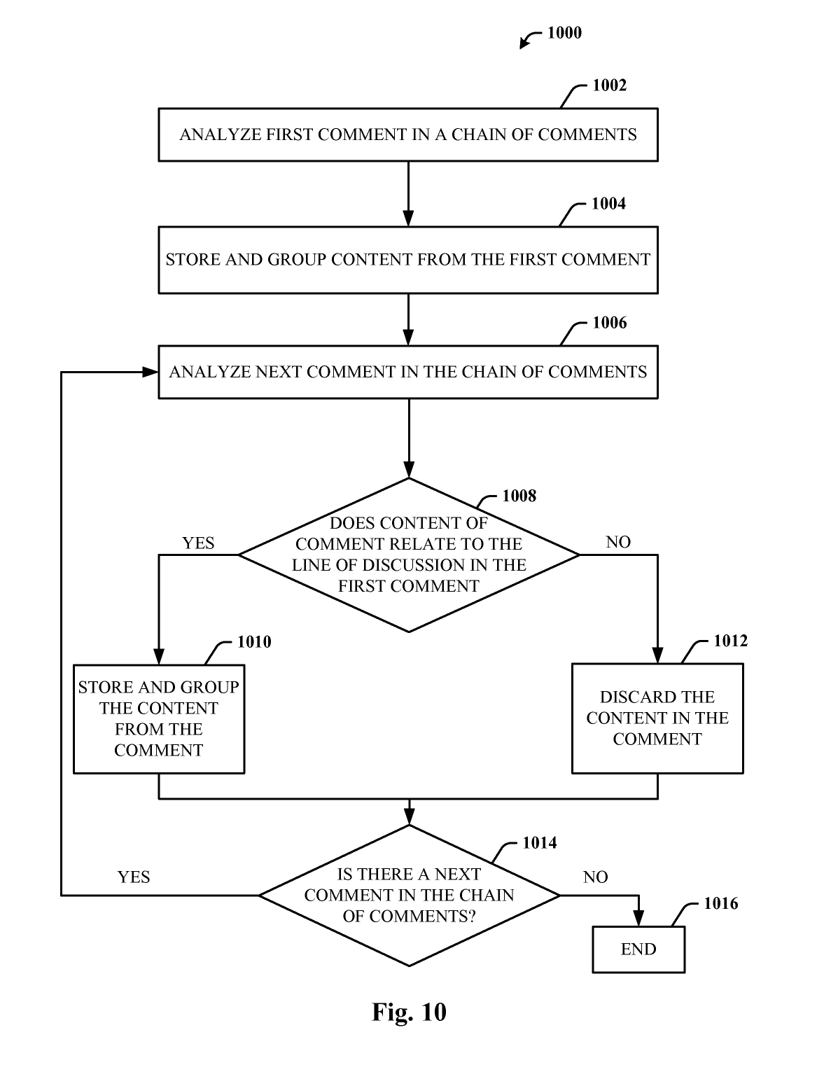

Referring to FIG. 10, illustrated is an example methodology 1000 for filtering information in accordance with aspects described herein. Methodology 1000 can begin at block 1002, wherein a first comment in a chain of comments is analyzed. At 1004, content from the first comment is stored and grouped. At 1006, a next comment in the chain of comments is analyzed. At 1008, it is determined if the content of the comment relates to the line of discussion in the first comment. For example, if a first comment on a blog relates to a specific product, and the next comment provides additional information related to the specific product, then the next comment relates to the line of discussion. However, if the next comment is addressed to another user on the blog, and does not relate to the specific product, then the next comment does not relate to the line of discussion. If yes, 1010 stores and groups the content from the comment. If no, 1012 discards the content of the comment. Then, 1014 determines if there is a next comment in the chain of comments. If yes, methodology 1000 returns to 1006 to analyze a next comment. If not, methodology 1000 proceeds to 1016 to end the methodology 1000. It is to be appreciated that analyzing comments is for illustrative purposes and that other types of information not found in comments may be analyzed using methodology 1000, such as analyzing data files, streams of information, news feeds, etc.

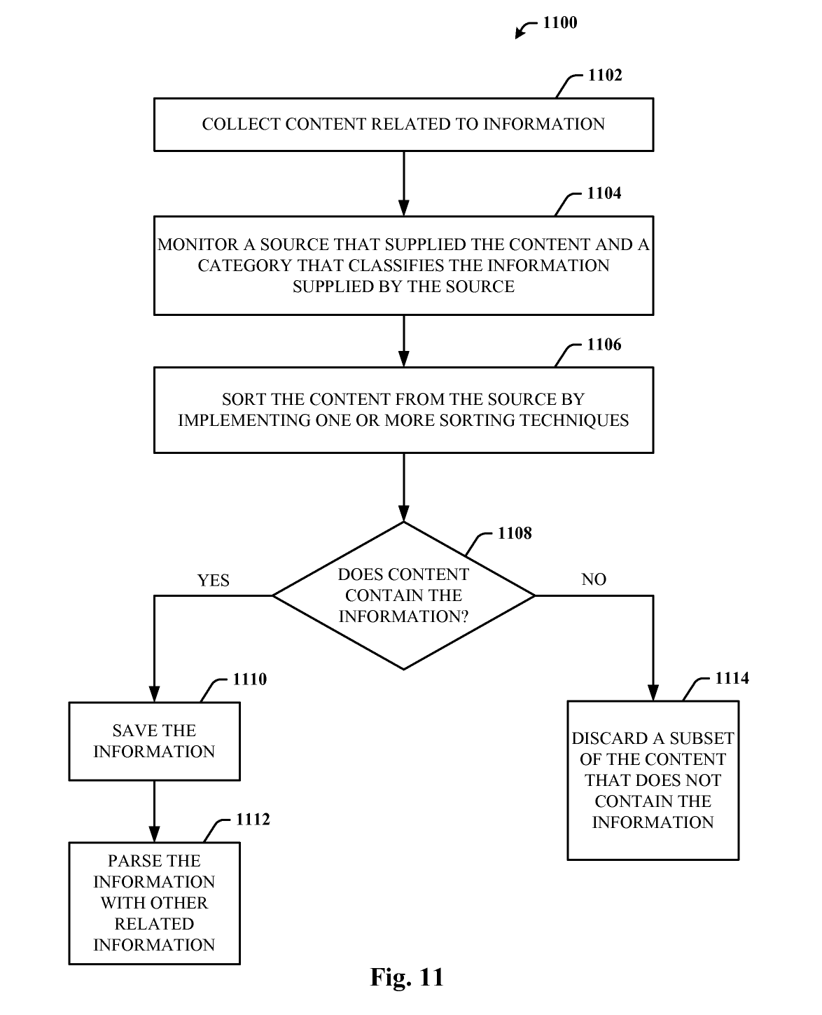

Referring to FIG. 11, illustrated is an example methodology 1100 for collecting and sorting information in accordance with aspects described herein. Methodology 1100 can begin at block 1102, wherein content related to information is collected. At 1104, a source that supplied the content and a category that classifies the information is monitored. At 1106, one or more sorting techniques are implemented to sort the content from the source. At 1108, it is determined if the content contains the information. If yes, 1110 saves the information. Then, at 1112, the information is parsed with other related information. If no, 1114 discards a subset of the content that does not contain the information.

### Exemplary Networked and Distributed Environments

One of ordinary skill in the art can appreciate that the various non-limiting embodiments of the aggregator systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the aggregation mechanisms as described for various non-limiting embodiments of the subject disclosure.

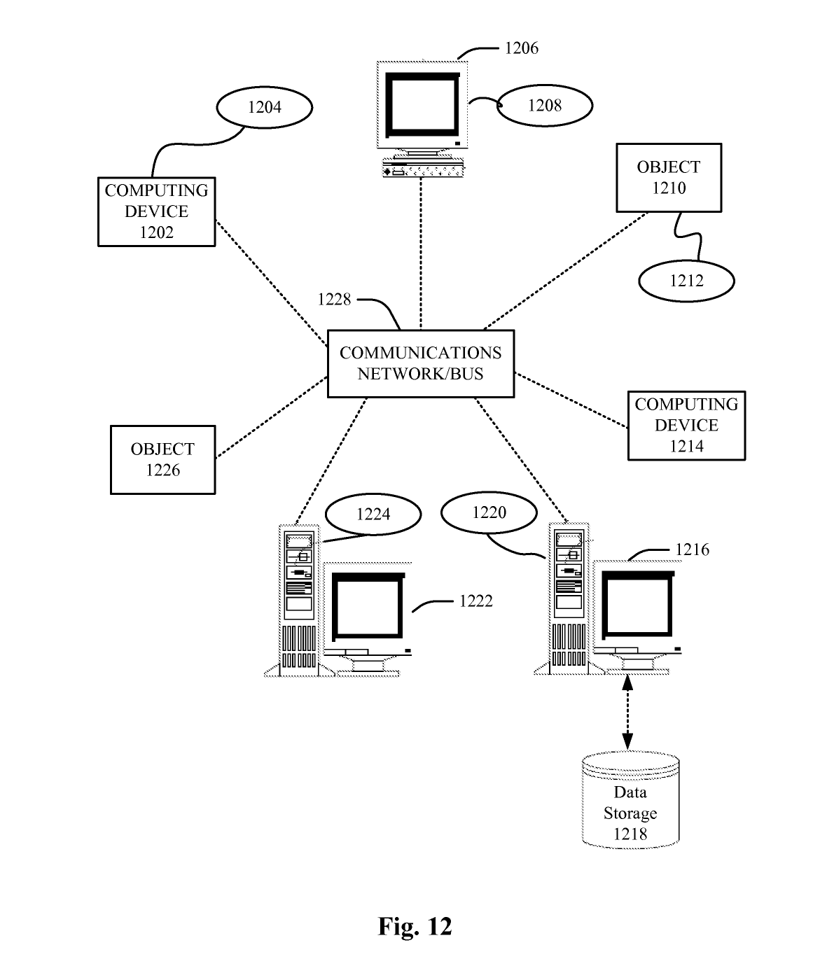

FIG. 12 provides a schematic diagram of an exemplary networked or distributed computing environment. The distributed computing environment comprises computing objects 1206, 1208, 1210, 1212, etc. and computing objects or devices 1220, 1222, 1224, 1226, etc., which may include programs, methods, data stores, programmable logic, etc. It can be appreciated that computing objects 1206, 1208, 1210, 1212, etc. and computing objects or devices 1220, 1222, 1224, 1226, etc. may comprise different devices, such as personal digital assistants (PDAs), audio/video devices, mobile phones, MP3 players, personal computers, laptops, etc.

Each computing object 1206, 1208, 1210, 1212, etc. and computing objects or devices 1220, 1222, 1224, 1226, etc. can communicate with one or more other computing objects 1206, 1208, 1210, 1212, etc. and computing objects or devices 1220, 1222, 1224, 1226, etc. by way of the communications network 1228, either directly or indirectly. Even though illustrated as a single element in FIG. 12, communications network 1228 may comprise other computing objects and computing devices that provide services to the system of FIG. 12, and/or may represent multiple interconnected networks, which are not shown. Each computing object 1206, 1208, 1210, 1212, etc. or computing object or device 1220, 1222, 1224, 1226, etc. can also contain an application, which can be stored in the data storage 1218, that might make use of an API, or other object, software, firmware and/or hardware, suitable for communication with or implementation of the aggregation systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the aggregator systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 12, as a non-limiting example, computing objects or devices 1220, 1222, 1224, 1226, etc. can be thought of as clients and computing objects 1206, 1208, 1210, 1212, etc. can be thought of as servers where computing objects 1206, 1208, 1210, 1212, etc., acting as servers provide data services, such as receiving data from client computing objects or devices 1220, 1222, 1224, 1226, etc., storing of data, processing of data, transmitting data to client computing objects or devices 1220, 1222, 1224, 1226, etc., although any computer can be considered a client, a server, or both, depending on the circumstances. Any of these computing devices may be processing data, or requesting services or tasks that may implicate the aggregation filtering techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1240 or bus is the Internet, for example, the computing objects 1206, 1208, 1210, 1212, etc. can be Web servers with which other computing objects or devices 1220, 1222, 1224, 1226, etc. communicate via any of a number of known protocols, such as the hypertext transfer protocol (HTTP). Computing objects 1206, 1208, 1210, 1212, etc. acting as servers may also serve as clients, e.g., computing objects or devices 1220, 1222, 1224, 1226, etc., as may be characteristic of a distributed computing environment.

### Exemplary Computing Device

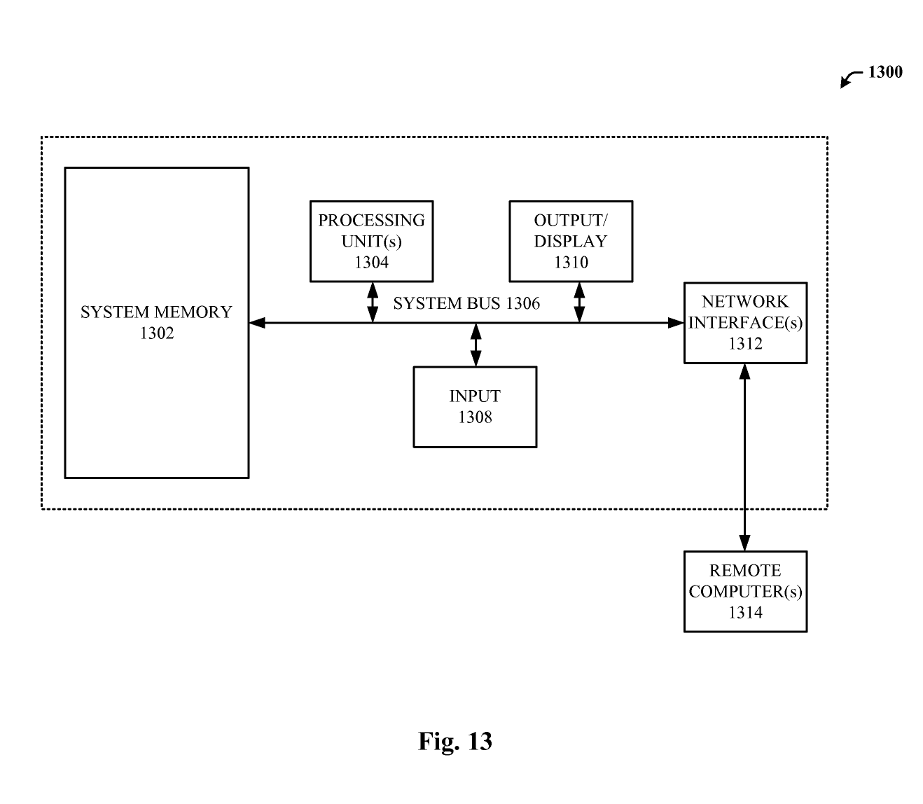

As mentioned, advantageously, the techniques described herein can be applied to any device where it is desirable to aggregate information. It is to be understood, therefore, that handheld, portable and other computing devices and computing objects of all kinds are contemplated for use in connection with the various non-limiting embodiments, i.e., anywhere that a device may wish to aggregate information on behalf of a user or set of users. Accordingly, the below general purpose remote computer described below in FIG. 13 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 13 thus illustrates an example of a suitable computing system environment 1300 in which one or aspects of the non-limiting embodiments described herein can be implemented, although as made clear above, the computing system environment 1300 is only one example of a suitable computing environment and is not intended to suggest any limitation as to scope of use or functionality. Neither should the computing system environment 1300 be interpreted as having any dependency or requirement relating to any one or combination of components illustrated in the exemplary computing system environment 1300.

With reference to FIG. 13, an exemplary remote device for implementing one or more non-limiting embodiments includes a general purpose computing device in the form of a computer 1310. Components of computer 1310 may include, but are not limited to, a processing unit 1304, a system memory 1302, and a system bus 1306 that couples various system components including the system memory to the processing unit 1304.

Computer 1310 typically includes a variety of computer readable media and can be any available media that can be accessed by computer 1310. The system memory 1302 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1302 may also include an operating system, application programs, other program modules, and program data.

A user can enter commands and information into the computer 1310 through input devices 1308. A monitor or other type of display device is also connected to the system bus 1306 via an interface, such as output interface 1312. In addition to a monitor, computers can also include other peripheral output devices such as speakers and a printer, which may be connected through output interface 1312.

The computer 1310 may operate in a networked or distributed environment using logical connections to one or more other remote computers, such as remote computer 1314. The remote computer 1314 may be a personal computer, a server, a router, a network PC, a peer device or other common network node, or any other remote media consumption or transmission device, and may include any or all of the elements described above relative to the computer 1310. The logical connections depicted in FIG. 16 include a network, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the aggregation filtering techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store requested information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” can include one criterion, or many criteria.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims and their equivalents.

1. A method, comprising:
retrieving data comprising content requested from at least one source;
tracking which of the at least one source supplied the data and a category that classifies the content supplied by the at least one source;
filtering the data from the at least one source to acquire the content by implementing one or more filtering techniques; and
storing the content in data storage and discarding a subset of the data not containing the content, wherein the content is grouped with other content related to the content.

2. The method of claim 1, wherein the storing the content includes storing the content with the other content as a categorized structure comprising information related to the content.

3. The method of claim 1, wherein the retrieving the data includes retrieving the data from a previous source from which previously acquired content including the other content was retrieved.

4. The method of claim 1, wherein the tracking includes tracking one or more data fields in connection with the content to classify the content.

5. The method of claim 1, wherein the retrieving the data includes retrieving the data based on at least one user specified search criterion.

6. The method of claim 1, wherein the retrieving the data includes automatically retrieving the data based on previously acquired content stored in the data storage.

7. The method of claim 1, wherein the tracking further comprises storing an indicator with the content to identify which of the at least one source supplied the data.

8. The method of claim 1, wherein the retrieving the data from the at least one source includes retrieving online information.

9. The method of claim 1, wherein the retrieving the data includes retrieving more frequently requested data before data that is requested less frequently than the more frequently requested data.

10. The method of claim 9, wherein the filtering the data includes implementing less of the one or more filtering techniques for the data that is requested less frequently than the more frequently requested data.

11. The method of claim 1, wherein the filtering the data includes comparing the content with at least one similarity associated keyword stored in the data storage.

12. The method of claim 1, wherein the filtering the data includes filtering an entire chain of threaded information to determine which of the threaded information relates to the content.

13. The method of claim 1, wherein the filtering the data includes filtering an entire chain of threaded information comprising the content and discarding the subset of the data in the chain of threaded information that does not relate to the content in the chain of threaded information.

14. The method of claim 1, further comprising displaying the content and the other content as one or more separate notifications on a portal viewed by a user device, wherein the one or more separate notifications each contain a compilation of information from the at least one source.

15. An aggregator system, comprising:
a monitoring component configured to retrieve data comprising content from at least one source, and track which of the at least one source supplied the data and a category that classifies the content supplied by the at least one source; and
a filtering component configured to filter the data from the at least one source to acquire the content by implementation of one or more filters, store the content in data storage and discard a portion of the data not containing the content, wherein the content is grouped with other content related to the content.

16. The aggregator system of claim 15, wherein the content and the other content form a categorized structure comprising information related to the content.

17. The aggregator system of claim 15, wherein one or more data fields are stored in connection with the content to classify the content.

18. The aggregator system of claim 15, wherein the data is retrieved based on at least one user specified search criterion.

19. The aggregator system of claim 15, wherein the data is retrieved automatically based on previously acquired content stored in the data storage.

20. The aggregator system of claim 15, wherein the data storage stores an indicator with the content to identify which of the at least one source supplied the data.

21. The aggregator system of claim 15, wherein more frequently requested data is retrieved before data requested less frequently than the more frequently requested data.

22. The aggregator system of claim 15, wherein the one or more filters compare the content with at least one similarity associated keyword stored in the data storage.

23. The aggregator system of claim 15, wherein the filtering component filters an entire chain of threaded information to determine which of the threaded information relates to the content.

24. A computer readable storage medium comprising computer executable instructions that, in response to execution by a computing system, cause the computing system to perform operations, comprising:
retrieving data comprising content requested from at least one source;
tracking which of the at least one source supplied the data and a category that classifies the content supplied by the at least one source;
filtering the data from the at least one source to acquire the content by implementing one or more filtering techniques; and
storing the content in data storage and discarding a subset of the data not containing the content, wherein the content is grouped with other content related to the content.

25. The computer readable storage medium of claim 24, wherein the storing the content includes storing the content with the other content as a categorized structure comprising information related to the content.

26. The computer readable storage medium of claim 24, wherein the tracking includes tracking one or more data fields in connection with the content to classify the content.

27. The computer readable storage medium of claim 24, wherein the retrieving the data includes retrieving the data based on at least one user specified search criterion.

28. The computer readable storage medium of claim 24, wherein the retrieving the data includes automatically retrieving the data based on previously acquired content stored in the data storage.

29. The computer readable storage medium of claim 24, wherein the tracking further comprises storing an indicator with the content to identify which of the at least one source supplied the data.

30. The computer readable storage medium of claim 24, wherein the retrieving the data includes retrieving more frequently requested data before data that is requested less frequently than the more frequently requested data.

31. The computer readable storage medium of claim 24, wherein the filtering the data includes comparing the content with at least one similarity associated keyword stored in the data storage.

32. The computer readable storage medium of claim 24, wherein the filtering the data includes filtering an entire chain of threaded information to determine which of the threaded information relates to the content.

33. A system, comprising:
means for retrieving data comprising content requested from at least one source;
means for tracking which of the at least one source supplied the data and a category that classifies the content supplied by the at least one source;
means for filtering the data from the at least one source to acquire the content by implementing one or more filtering techniques; and
means for storing the content in data storage and discarding a subset of the data not containing the content, wherein the content is grouped with other content related to the content.

34. A device, comprising:
a retrieving component configured to obtain data comprising content requested from at least one source;
a tracking component configured to identify which of the at least one source supplied the data and a category that classifies the content supplied by the at least one source;
a filtering component configured to sort the data from the at least one source to acquire the content by implementation of one or more filters; and
a storage component configured to save the content in data storage and discard a subset of the data not containing the content, wherein the content is grouped with other content related to the content.

35. The device of claim 34, further comprising a display component configured to display the content and the other content.

36. A method, comprising:
collecting content related to information;
monitoring a source that supplied the content and a category that classifies the information supplied by the source;
sorting the content from the source by implementing one or more sorting techniques; and
saving the information and discarding a subset of the content not containing the information, wherein the information is parsed with other information related to the information.

37. The method of claim 36, wherein the collecting the content includes collecting the content from a previous source from which previously acquired information including the other information was collected.

38. The method of claim 36, further comprising storing one or more data fields in connection with the information to classify the information.

39. The method of claim 36, further comprising linking an indicator with the information to identify the source that supplied the information.
